(19) United States
(12) Patent Application Publication
(10) Pub. No.: US 2008/0129644 A1
(43) Pub. Date: Jun. 5, 2008

(54) BUILT-IN TYPE ANTENNA APPARATUS FOR MOBILE TERMINAL

(75) Inventors: Jeong-Ah SEO, Gumi-si (KR); Jae-Ho Lee, Yongin-si (KR); Jeong-Wan Park, Gumi-si (KR); Young-Hwan Kim, Daegu (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/773,563

(22) Filed: Jul. 5, 2007

(30) Foreign Application Priority Data
Dec. 5, 2006 (KR) 122431/2006

(51) Int. Cl. H01Q 21/00

(52) U.S. Cl. 343/893

(57) ABSTRACT

A built-in antenna apparatus for a mobile terminal is provided. The built-in antenna apparatus includes a first planar antenna having a first feeding point for providing a first radiation pattern, a second planar antenna having a second feeding point for providing a second radiation pattern, the second planar antenna being located adjacent to the first planar antenna, and a ground stub having a ground point for providing a ground pattern, the ground stub placed a distance apart from the first and the second planar antennas.

### PRIORITY

This application claims the benefit under 35 U.S.C. §119(a) of a Korean patent application filed on Dec. 5, 2006 in the Korean Industrial Property Office and assigned Serial No. 2006-122431, the entire disclosure of which is hereby incorporated by reference.

### BACKGROUND OF THE INVENTION

1. Field of the Invention

The present invention relates to a built-in antenna apparatus for a mobile terminal. More particularly, the present invention relates to a built-in antenna apparatus for a mobile terminal, which includes dual planar antennas for providing a feeding point and a radiation pattern, respectively, and a ground stub for providing a ground pattern beyond a distance from the dual planar antennas.

2. Description of the Related Art

Generally, the term “mobile communication apparatus” refers to portable devices which can communicate with other devices using radio frequency. Such mobile communication apparatuses include HHP, CT-2, cellular phones, digital phones, personal communication services (PCS), personal digital assistants (PDA) and the like, which can be classified into various types according to their shapes. For example, wireless communication terminals can be classified as bar-type, flip-type or folder-type terminals depending on their shapes. The conventional portable terminals as described above have an antenna apparatus, a data input device, a data output device and a data transmission device. Usually, an LCD is used as the data output device.

In general, a key pad for inputting data includes an array of keys. The keys include a send (SND) key for initiating a call, a cancel key, a clear (CLR) key, number keys, character keys, an END key, function keys, a power (PWR) key and the like.

Recently, the mobile communication apparatus is also providing various functions in addition to communication. For example, a device for listening to radio broadcasting, an MP3 player, a multimedia player and a remote controller as well as an audio service terminal for voice communication.

In addition, mobile terminals which also take pictures and to transmit data with high speed have been developed. Consequently, a plurality of devices for providing the various functions must be mounted in the mobile phone, thus making the space for mounting a built-in antenna smaller.

Further, the antenna apparatus must be mounted on an appropriate position of the terminal so as to receive and transmit signals.

Generally, the antenna apparatus may include a whip antenna and a helical antenna.

The helical antenna is predominantly used to lower the entire height of the terminal. Differently from the rod antenna which is used with an extended state as desired, the helical antenna is removably attached as a protrusion onto the upper side of the terminal. When the antenna is protruded from the terminal, the aesthetics of the terminal are diminished.

Recently, built-in antennas are widely used in the terminals so as to resolve the above disadvantages. Usually, a chip antenna or a Planar Inverted F Antenna (PIFA) is used as the built-in antenna.

Referring to FIGS. 1 and 2, the built-in antenna 2 includes an antenna radiator having a length of about λ/4 and having a function as a radiator. A feeding point 5 is electrically connected to the antenna radiator at a distance. Both the antenna radiator and the feeding point are mounted on a printed circuit board (PCB) 3.

The built-in antenna 2 includes the feeding point 5 and a ground point 6 adjacent to the feeding point. The ground point 6 is electrically connected to a ground stub 7.

Referring to FIG. 3, the feeding point 5 is connected to the PCB 3 such that a radiation pattern generated by antenna radiator 4 is applied to the PCB 3 and the adjacent ground point 6 is connected to the PCB 3 such that radiator pattern signals generated by the ground stub 7 are applied to the PCB 3.

Referring back to FIG. 1 which illustrates a current distribution of the antenna, if the radiation pattern is generated by the antenna radiator and the ground stub 7, current distribution E1 is concentrated about the feeding point 5 to create a hot spot.

Herein, the hot spot refers to a high-density portion of the current and can be indicated as a Specific Absorption Rate (SAR).

However, as the conventional mobile terminals require good appearance as well as various functions, the built-in antenna is now predominantly used in compact and slim type terminals. Therefore, the space for mounting antenna becomes small. Further, since the camera module 9, speaker module 8 and the like are additionally mounted as indicated in FIG. 3, the space for mounting the antenna and thus the performance of the antenna, are limited.

As the volume of the built-in antenna is reduced, a Specific Absorption Rate (SAR) of a human body has become an important issue. In the case of the existing antenna, and in considering enhancing the radiation performance as much as possible, the slim terminal cannot arrange a sufficient distance between a human body and the antenna, so that the slim terminal has a high SAR. In addition, since the current distribution is concentrated on the feeding point, it is difficult to achieve a level of radiation performance of the antenna and the SAR is further increased.

### SUMMARY OF THE INVENTION

An aspect of the present invention is to address at least the above-mentioned problems and/or disadvantages and to provide at least the advantages described below. Accordingly, an aspect of the present invention is to provide a built-in antenna apparatus for a mobile terminal which includes a plurality of planar antennas for providing a plurality of feeding points and a plurality of independent radiation patterns, thereby reducing the SAR and improving the radiation performance of the antenna.

Also, another aspect of the present invention is to provide a built-in antenna apparatus for a mobile terminal. The antenna apparatus includes dual planar antennas for providing a feeding point and a radiation pattern respectively, and a ground stub for providing a ground pattern beyond a distance from the dual planar antennas, so that the built-in antenna apparatus can reduce the SAR and improve the radiation by spreading the current distribution and by increasing the distance between the body and the antenna.

In accordance with an aspect of the present invention, a built-in antenna apparatus for a mobile terminal is provided. The antenna apparatus includes a first planar antenna having a first feeding point for providing a first radiation pattern, a second planar antenna having a second feeding point for providing a second radiation pattern, the second planar antenna being located adjacent to the first planar antenna, and a ground stub having a ground point for providing a ground pattern, the ground stub being at a distance from the first and the second planar antennas.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a perspective view illustrating a mobile terminal with a conventional built-in antenna;

FIG. 2 is a plan view illustrating a conventional built-in antenna;

FIG. 3 is a plan view illustrating a conventional mobile terminal of FIG. 1 with a camera module and a speaker;

FIG. 4 is a perspective view illustrating a built-in antenna for a mobile terminal according to an exemplary embodiment of the present invention;

FIG. 5 is a plan view illustrating a built-in antenna for a mobile terminal according to an exemplary embodiment of the present invention;

FIG. 6 is a perspective view illustrating a built-in antenna according to an exemplary embodiment of the present invention assembled with the mobile terminal;

FIG. 7(a) is a graph illustrating a plotting of Specific Absorption Rate (SAR) of a conventional built-in antenna;

FIG. 7(b) is a graph illustrating a plotting of SAR of a built-in antenna according to an exemplary embodiment of the present invention; and

FIG. 8 is a view illustrating radiation pattern gains of a conventional built-in antenna and a built-in antenna according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of known functions and configurations will be omitted for clarity and conciseness.

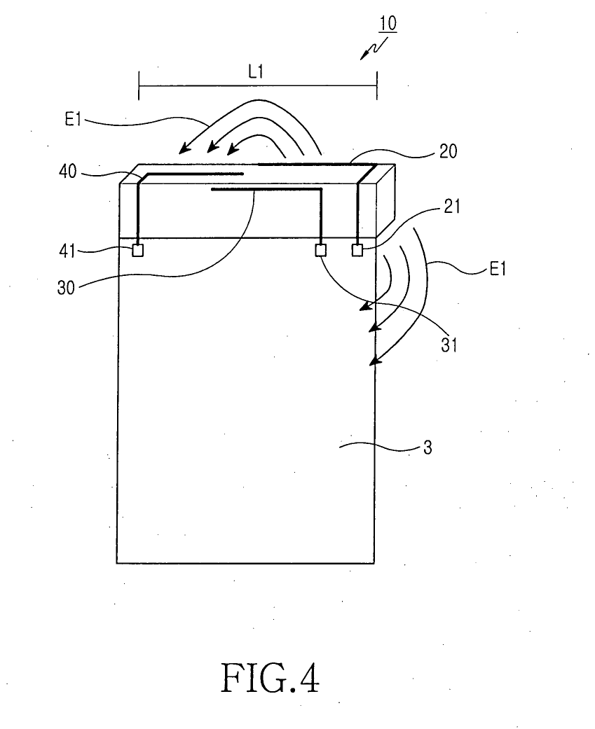

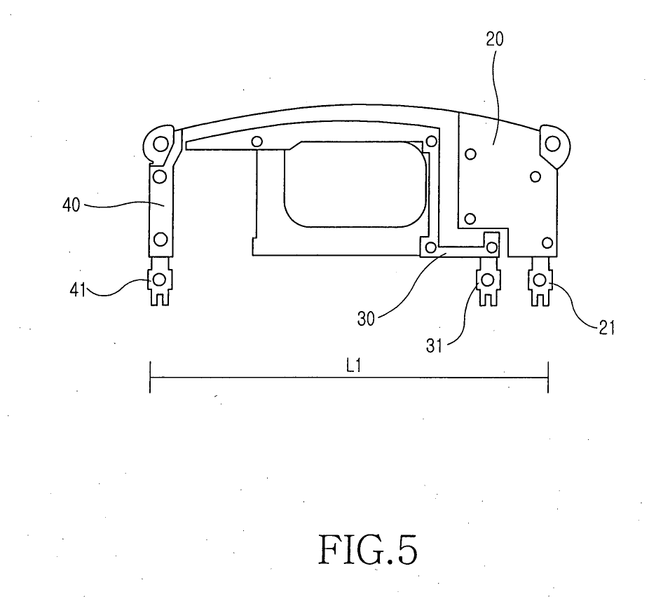

Referring to FIGS. 4 and 5, a built-in antenna apparatus 10 for a mobile terminal includes a first planar antenna 20, a second planar antenna 30 and a ground stub 40. The first planar antenna 20 located in the terminal has a first feeding point 21 and provides a first radiation pattern. The second planar antenna 30 is located adjacent to the first planar antenna 20, has a second feeding point 31 and provides a second radiation pattern which is independent of the first radiation pattern. The ground stub 40 is located at a distance L1 from the first and the second planar antennas 20 and 30 and is provided with a ground point 41 to provide a ground pattern which is independent of the first and the second radiation patterns.

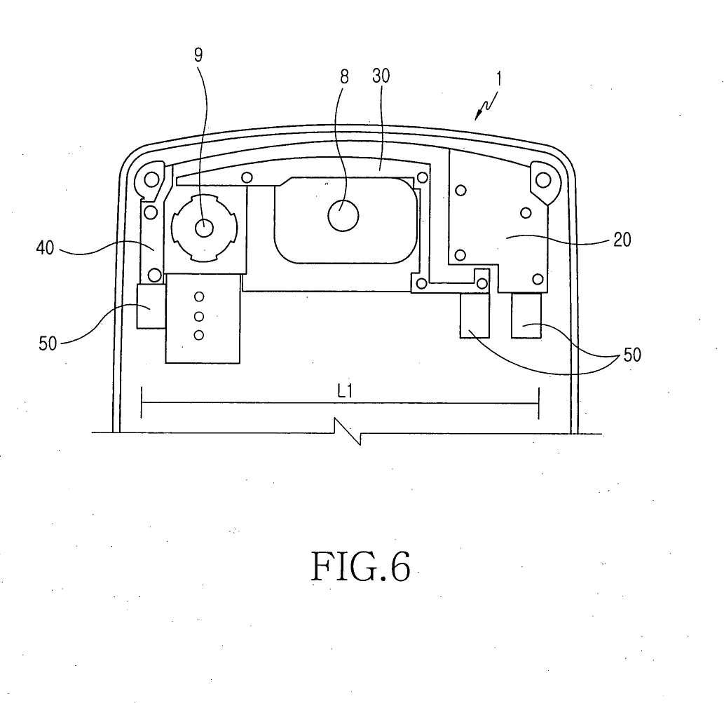

Referring to FIG. 6, a PCB 3 of the terminal 1 is provided with at least one connecting pad 50 to electrically connect the first and the second feeding points 21 and 31 to the ground point 41.

With reference to FIGS. 4 to 8, the built-in antenna according to an exemplary embodiment of the present invention is described more specifically.

The built-in antenna 10 for a mobile terminal 1 includes a first planar antenna 20, a second planar antenna 30 and a ground stub 40, as shown in FIGS. 4 and 5.

The first and the second planar antennas 20 and 30 are located adjacent to a speaker 8 and a camera module 9 in the terminal 1.

The first planar antenna 20 is provided with a first feeding point 21 and provides a first radiation pattern. The second planar antenna 30 is located adjacent to the first planar antenna 20, is provided with a second feeding point 31, and provides a second radiation pattern.

The ground stub 40 is located at a distance L1 from the first and the second planar antennas 20 and 30. The ground stub is provided with a ground point 41 and provides a ground pattern.

Since the PCB 3 of the terminal 1 is provided with at least one connecting pad 50 to electrically connect the first and the second feeding points 21 and 31 to the ground point 41 as shown in FIG. 6, the first and the second feeding points 21 and 31 and the ground point 41 are electrically connected to the connecting pad 50.

Accordingly, when the mobile terminal 1 is used for wireless communication, the first and the second radiation patterns are provided by the first and the second planar antennas 20 and 30. At that time, if signals of the first and the second radiation patterns are enhanced to a maximum by using the first and the second feeding points 21 and 31, the ground pattern about the ground point 41 is provided at the distance L1 from the first and the second planar antennas 20 and 30.

When current is concentrated on the first and the second feeding points 21 and 31, the ground radiation pattern is applied to the ground feeding point 41 through the ground stub 40 so as to prevent current concentration.

Consequently, the current is dispersed by the first and the second feeding point 21 and 31 and the ground point 41 such that an effect of reduced SAR is obtained by lowering the density of the current in a hot spot, and thus by spreading the hot spot.

The ground radiation pattern directed to the ground point 41 is formed, thereby leading the current to the ground stub 40 and dispersing the current concentrated to the first and the second feeding points 21 and 31.

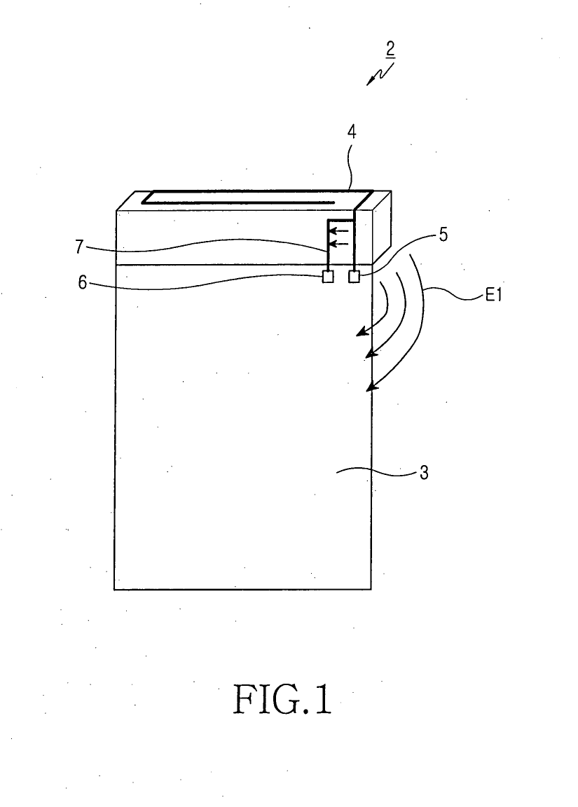

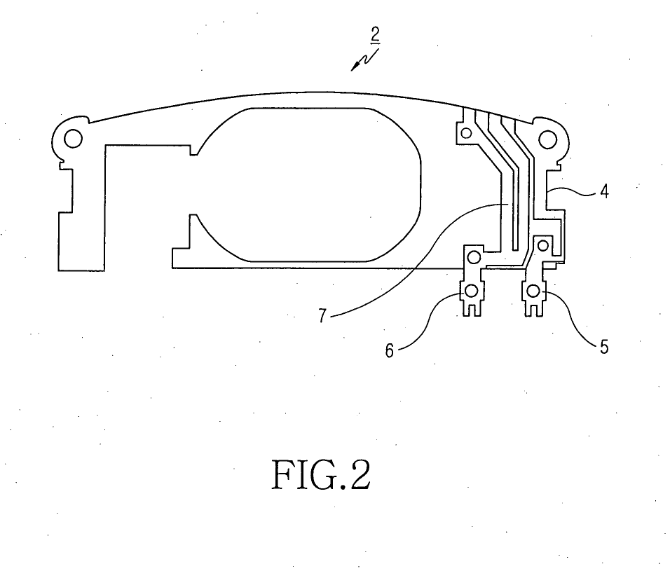

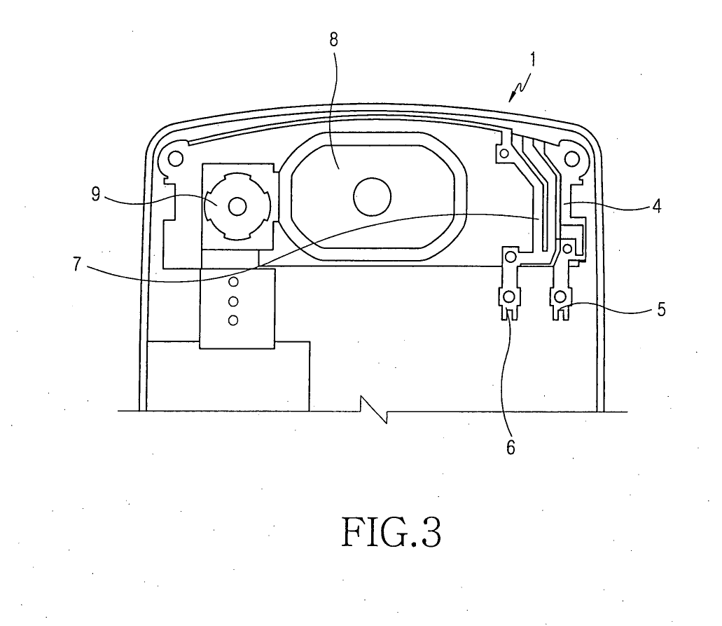

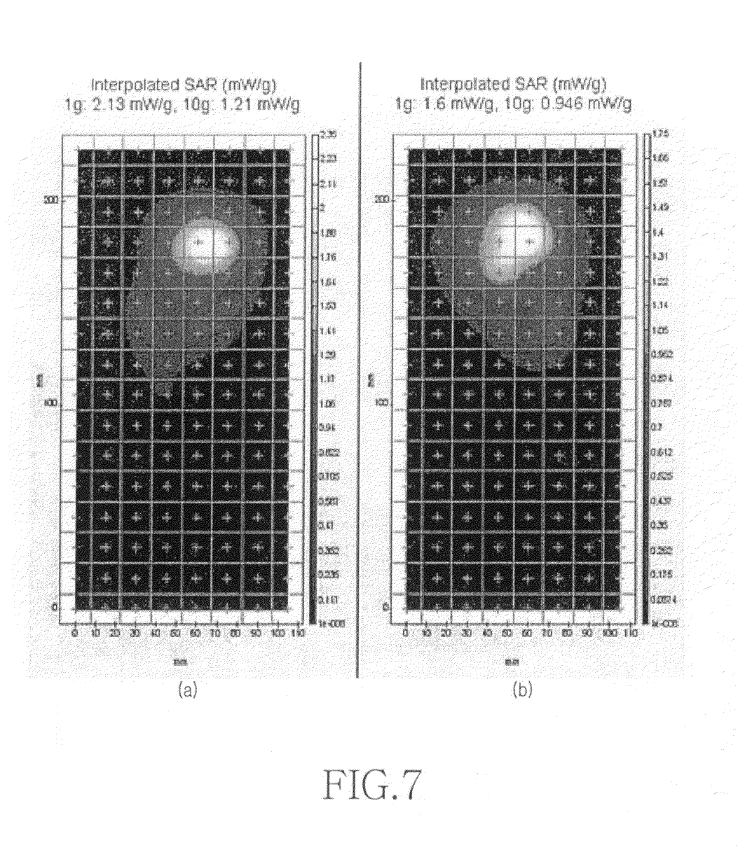

FIGS. 7(a) and 7(b) illustrate test results of the SAR of the conventional built-in antenna and the built-in antenna of an exemplary embodiment of the present invention, respectively. In FIG. 7(a), the radiation pattern of the conventional built-in antenna 2 appears as a non-uniform or a localized current distribution concentrated about one feeding point, for example feeding point 5 of FIG. 1. In contrast, the radiation pattern of an exemplary embodiment of the present invention appears as a stable current pattern spread about a plurality of feeding points, for example feeding points 21, 31 and 41 of FIG. 4, thereby reducing the SAR.

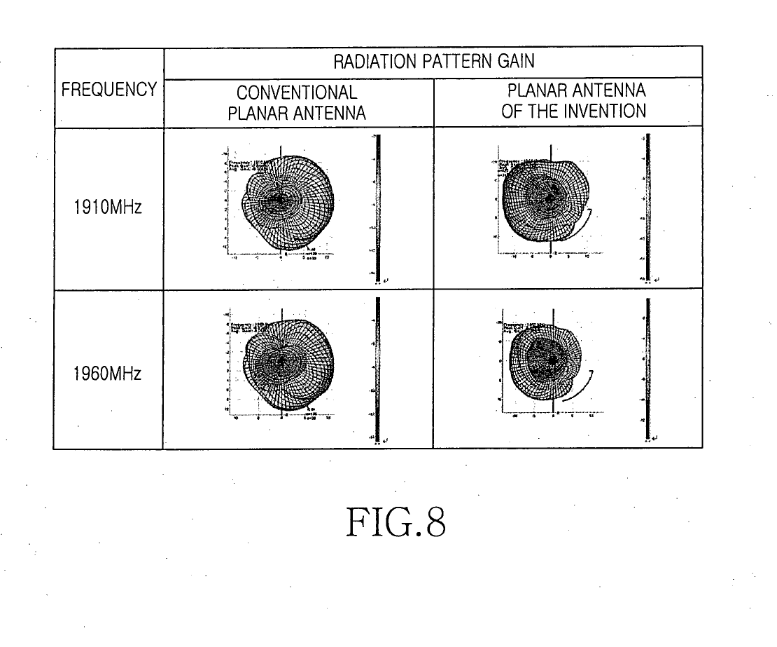

FIG. 8 illustrates radiation pattern gains of the built-in antenna 10 of an exemplary embodiment of the present invention and the conventional built-in antenna 2 at frequencies of 1,910 MHz and 1,960 MHz. The conventional built-in antenna 2 appears as an irregular, localized radiation pattern in the shape of a star. In contrast, the radiation pattern of an exemplary embodiment of the present invention has a circular shape which is uniformly distributed without eccentricity such that the SAR of an exemplary embodiment of the present invention is reduced more than that of the conventional built-in antenna. As a result, the built-in antenna according to an exemplary embodiment of the present invention provides a more stable performance.

As describe above, the exemplary embodiments of the present invention can reduce the SAR and improve the performance of the built-in antenna by providing a uniformly distributed radiation pattern with the first and the second planar antennas and the ground stub.

While the invention has been shown and described with reference to certain exemplary embodiments thereof, it will be understood by those skilled in the art that various changes in form and details may be made therein without departing from the spirit and scope of the invention as defined by the appended claims. For example, the present invention can be adapted to any portable terminals and their equivalents.

What is claimed is:

1. A built-in antenna apparatus for a mobile terminal, comprising:
a first planar antenna having a first feeding point for providing a first radiation pattern;
a second planar antenna having a second feeding point for providing a second radiation pattern, the second planar antenna being located adjacent to the first planar antenna; and
a ground stub having a ground point for providing a ground pattern, the ground stub being placed at a distance apart from the first and the second planar antennas.

2. The built-in antenna apparatus for a mobile terminal of claim 1, wherein the first and the second radiation patterns are provided independent of each other.

3. The built-in antenna apparatus for a mobile terminal of claim 1, wherein the ground pattern is provided independent of and at a distance from the first and the second radiation patterns.

4. The built-in antenna apparatus for a mobile terminal of claim 1, wherein the terminal further comprises a printed circuit board which is provided with at least one connecting pad to electrically connect the first and the second feeding points to the ground point.

5. A built-in antenna apparatus for a mobile terminal, comprising:
at least two planar antennas for providing a plurality of feeding points and a plurality of independent radiation patterns; and
a ground stub having an independent ground point for providing a ground pattern, the ground stub being placed at a distance apart from the planar antennas.

6. The built-in antenna apparatus of claim 5, wherein the at least two planar antennas comprise dual planar antennas each of which has a feeding point for providing independent radiation pattern.

7. A mobile terminal comprising:
a camera;
a speaker; and
a built-in antenna comprising:
dual planar antennas each of which has a feeding point for providing an independent radiation pattern; and
a ground stub having an independent ground point for providing a ground pattern, the ground stub being placed at a distance apart from the planar antennas.
